(19) United States
(12) Patent Application Publication
(10) Pub. No.: US 2014/0017038 A1
(43) Pub. Date: Jan. 16, 2014

(54) APPARATUS FOR APPLYING ADHESIVE AND METHOD FOR OPERATING SUCH AN APPARATUS

(71) Applicant: HEIDELBERGER DRUCKMASCHINEN AG, Heidelberg (DE)

(72) Inventors: JENS KNOEFEL, BRANDIS (DE); FRANK SOMMERER, LEIPZIG (DE); MARTIN STRASSBURGER, REGIS-BREITINGEN (DE)

(21) Appl. No.: 13/938,775

(22) Filed: Jul. 10, 2013

(30) Foreign Application Priority Data
Jul. 10, 2012 (DE) 102012014974.3

(51) Int. Cl. B42C 9/00

(52) U.S. Cl. CPC B42C 9/0006
USPC 412/6; 412/37; 412/14

(57) ABSTRACT

An apparatus for applying adhesive to a book block spine has an application nozzle, a nozzle opening of the application nozzle being variable and able to be adapted to the thickness of a book block to be processed. The application nozzle has a first chamber for providing adhesive and a second chamber. A first slide is provided in the region of the first chamber for changing a width of the first chamber. A second slide is provided in the region of the second chamber for changing the volume of the second chamber. The changing takes place in such a way that, when there is a change in the width of the first chamber, the sum of the volume of the first chamber and the second chamber remains constant. The apparatus allows a strictly defined application of adhesive possible even when there is a changeover to a narrower book block spine.

### CROSS-REFERENCE TO RELATED APPLICATION

This application claims the priority, under 35 U.S.C. §119, of German application DE 10 2012 014 974.3, filed Jul. 10, 2012; the prior application is herewith incorporated by reference in its entirety.

### BACKGROUND OF THE INVENTION

### Field of the Invention

The invention relates to an apparatus for applying an adhesive, to a method for adapting an adhesive application nozzle and to a further apparatus for applying adhesive.

In the production of books by the perfect binding method, adhesive is either applied to the spine of a book by roll applicators or alternatively by application nozzles. The adhesive takes the form of dispersion adhesives, hot-melt adhesives or combinations of dispersion and hot-melt adhesives. Polyurethane (PU) adhesive has set itself apart in recent years as a hot-melt adhesive that has particularly good page-tear out resistance and achieves particularly advantageous results in the 180° opening behavior of the book block, known as the lay-flat behavior. The adhesive can also be used advantageously for poorer paper quality, for example coated grades of paper, in which the proportion of coating constituents outweighs the fiber content required for strength, and which also do not allow themselves to be roughened as well to expose the fiber for the adhesive bonding. The terms adhesive and glue are used synonymously hereinafter.

The use of PU is problematic inasmuch as it is only able to a limited extent to be used for roll applicators, since the relatively thin adhesive layers of a few 100 micrometers can, in technical terms, only be handled with difficulty in a roll applicator, and the setting, operating and cleaning effort involved is very great. Moreover, in contact with the environment, the adhesive releases harmful isocyanates, which likewise restricts the extent to which the PU adhesive can be used for roll applicators. Moreover, the PU hardens prematurely in an oxygen atmosphere and under the influence of atmospheric humidity, in particular in the case of traditional roll applicators, which have a large surface with respect to the atmosphere. This disadvantage of roll applicators is manifested in particular in the case of short runs and frequently changing types of paper, as increasingly occur due to digital printing.

In order to obviate these disadvantages, nozzle application systems are increasingly being used, as shown for instance in U.S. Pat. No. 4,667,879 and European patents EP 1 033 262 and EP 550 913. All of these publications have the common factor that they search for ways of varying the width of the trace of adhesive. This is important for nozzles, since, unlike in a roll application system, the adhesive cannot flow back into the system outside the surface area to be provided with adhesive, and so, when a nozzle is set too wide, soiling of the system or of a major part of the apparatus cannot be avoided.

The nozzles are positioned on the spine of a book at a distance from it in a way corresponding to the desired thicknesses of adhesive. Furthermore, the nozzle is set to the product thickness. The necessary application volume of adhesive for a book block can be calculated from the dimensions of the product thickness, layer thickness and application length. Since the application of adhesive takes place while passing by the book block, the necessary application volume per unit of time is determined, and can for example be exactly supplied by a gear pump.

The setting of the application nozzle according to the product thickness is realized by exposing an application slit by axially or radially moving slides. This exposes a space that is located under the slit and is filled with adhesive, the width of which changes in proportion to the product thickness.

Solutions for adapting the nozzle width are already known for example from U.S. Pat. No. 4,667,879, German patent DE 100 23 895 and European patent EP 1 033 262.

European patent EP 2 319 707 discloses an apparatus for applying adhesive to a book block spine by a nozzle. In order to apply a strictly delimited film of glue, the supply of adhesive is clock-controlled. For this purpose, a controllable feed pump and a switchable valve are provided in the adhesive supply. To be able to end the supply of adhesive more quickly and abruptly break off the film of glue, an adhesive withdrawing device is placed between the valve and the nozzle. The adhesive withdrawing device takes up the book block adhesive from the moment that the application of glue is ended.

In the case of an inline interconnection of one or more digital printing machines with a perfect binding section, the cost-effectiveness can be increased significantly if different production batches with varying formats can be produced without an interruption in production being required (selective binding). Equally, it must be ensured that the first product of a new batch is saleable (1st run). Consequently, what may be called the setup reject wastage is no longer acceptable. In the case of spine gluing by a nozzle application system with a slide in the adhesive chamber there is the problem that, if the product thickness changes, the level of adhesive does not remain constant.

If there is an increase in the format, the level of adhesive in the chamber of the application nozzle falls and the following product is not supplied with adhesive in the front region.

If there is a reduction in the format, the adhesive oozes out from the nozzle slit and leads to smearing when the following product meets this surge or bead of adhesive. The falling level of adhesive when there is an increase in the format can be equalized relatively easily by the pump replenishing the chamber with a defined amount of adhesive.

### SUMMARY OF THE INVENTION

The object of the present invention is to provide an apparatus for applying adhesive and to describe a method for adapting an adhesive application nozzle that overcome the disadvantages of the prior art and make a strictly defined application of adhesive possible even when there is a changeover to a narrower book block spine.

This object is achieved by an apparatus for applying adhesive and a method for adapting an adhesive application nozzle.

The apparatus according to the invention serves for applying adhesive to a book block spine of a book block by an application nozzle. The application nozzle is line-connected to an adhesive supplying system and has a nozzle opening, which is variable and can be adapted to the thickness of a book block to be processed. The application nozzle advantageously has a first chamber for providing adhesive, which is adjacent the nozzle opening, and a second chamber, which is arranged between the nozzle opening and the adhesive supplying system. The term “chamber” means here a space, channel or the like that has a volume. The application nozzle also has a first slide in the region of the first chamber, for changing the width of the first chamber, and a second slide in the region of the second chamber, for changing the volume of the second chamber. The second chamber may be elongate or have a round configuration. In the case of being elongate, the slide can be moved in the chamber in a translatory manner. In the case of the round configuration, the slide can be moved in a rotary manner. The second chamber consequently represents a reservoir with a changeable volume, which can be used for taking up excess adhesive when a changeover is made from a book block of a greater thickness to a book block of a smaller thickness, or for dispensing additional adhesive when a changeover is made from a book block of a smaller thickness to a book block of a greater thickness. This ensures that, when changing the nozzle opening, excess adhesive does not cause a bead of adhesive, which could either clog the application nozzle or soil the book block.

In a particularly advantageous and therefore preferred development of the apparatus according to the invention, the first slide and the second slide are respectively assigned a drive, both drives being connected to a common control unit by data transmission technology, so that the drives can be activated by the control unit. The data transmission may in this case take place by way of cables or without cables, for example by radio. A respective drive may for example take the form of a stepping motor. It is particularly advantageous if the drives can be activated in such a way that, when there is a change in the width of the first chamber in accordance with the thickness of a book block respectively to be processed, the sum of the volume of the first chamber and the second chamber remains constant. In other words: in such a way that the adhesive that is displaced by the displacement of the first slide is taken up by the second chamber. The second chamber consequently represents an equalizing reservoir.

According to a first variant of a development of the apparatus according to the invention, the thickness of a book block respectively to be processed is stored in the control unit. The book block thickness may in this case be provided by an order management system. In an alternative development, the apparatus has a measuring device for recording the thickness of a book block to be processed, which is arranged upstream of the application nozzle and is connected to the control unit by data transmission technology.

In both cases, very quick adaptation of the application nozzle is ensured, so that so-called “selective binding” is made possible and even books in the “1st run” can be wetted with adhesive with the required quality and produced without reject wastage.

The invention also relates to a method for adapting an adhesive application nozzle of an apparatus for applying adhesive to a book block spine, in particular as described above. The method serves for adapting to the thickness of a book block to be processed and thereby has the below described steps.

In a first step, the first slide is displaced to change the width of a first chamber, in which adhesive is provided at a nozzle opening. The displacement takes place in such a way that the width of the first chamber is adapted to the thickness of a book block respectively to be processed.

In a second step, proceeding at the same time, there takes place a displacement of a second slide, which is assigned to a second chamber between the nozzle opening and an adhesive supplying system. The displacement thereby takes place in such a way that the sum of the volume of the first chamber and the second chamber remains constant. The volume of adhesive displaced by the first slide is consequently taken up in the second chamber by a yielding of the second slide.

In an advantageous development of the method according to the invention, the second step is only performed when the width of the first chamber is reduced, that is to say when there is a changeover to a narrower book block. In this case, adhesive that is not to escape through the nozzle opening of the application nozzle is displaced by the first slide, since otherwise a bead of adhesive would be formed at the nozzle opening or on the book block spine.

In an advantageous development of the method according to the invention, a withdrawal of the second slide into its starting position, in which the second chamber has its minimum volume, takes place in an additional step. Starting from the starting position thus reached, the second slide can subsequently be used again for volume equalization when there is a further reduction in the width of the first chamber. It is particularly advantageous if the withdrawal of the second slide takes place in concert with the activation of the adhesive supplying system and/or if the withdrawal of the second slide takes place in a plurality of small steps. It can be ensured by both of the aforementioned approaches that excessive adhesive that could not be taken up by the book block spine is not provided at any moment at the nozzle opening.

In an advantageous development of the method according to the invention, the ratio of the displacing speed of the first slide and the second slide is inversely proportional to the ratio of the cross sections of the first slide and the second slide. This achieves the effect that the volume of the second chamber is reduced to the same extent, i.e. increases equally rapidly, as the volume of the first chamber.

The invention also relates to an alternative apparatus for applying adhesive to a book block spine by an application nozzle, the application nozzle being line-connected to an adhesive supplying system and a nozzle opening of the application nozzle being variable and adaptable to the thickness of a book block to be processed. According to the invention, the application nozzle has a chamber adjacent the nozzle opening and a membrane for equalizing the volume of the chamber, the membrane being arranged adjacent the chamber. Also provided is a slide, for changing the width of the chamber. If adhesive is displaced when displacing the slide to reduce the width of the chamber, the membrane is stretched and represents an equalizing space, in which the displaced adhesive can be taken up. For this purpose, the membrane is produced from an elastic material. The apparatus has the advantage that only a small structural change of the application nozzle is required and a bead of adhesive caused by excess adhesive can be prevented with simple measures.

The described invention and the described advantageous developments of the invention also represent advantageous developments of the invention in any desired combination with one another.

Other features which are considered as characteristic for the invention are set forth in the appended claims.

Although the invention is illustrated and described herein as embodied in an apparatus for applying adhesive and a method for operating such an apparatus, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is an illustration of an adhesive application apparatus in a representation of an overview according to the invention;

FIG. 2A is an illustration showing the adhesive application apparatus with a setting for a wide book block spine; and

FIG. 2B is an illustration showing the adhesive application apparatus with the setting for a narrow book block spine.

### DETAILED DESCRIPTION OF THE INVENTION

Elements and components that correspond to one another are provided with the same reference numerals in the figures.

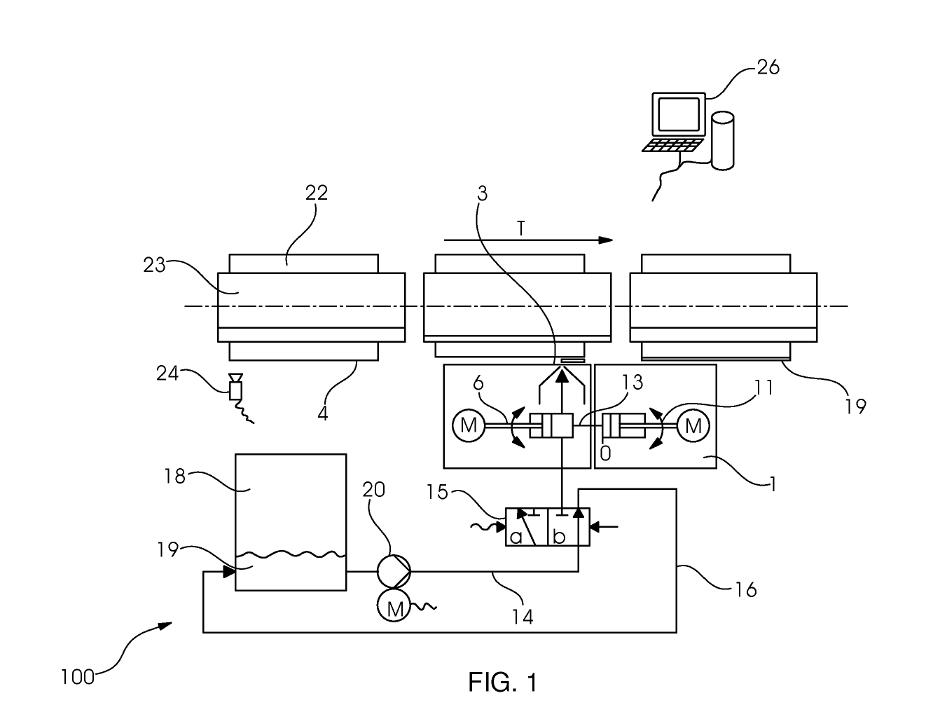

Referring now to the figures of the drawing in detail and first, particularly, to FIG. 1 thereof, there is shown an adhesive application apparatus 100 having an adhesive application nozzle 1, which bears an adhesive application head 2 with a nozzle slit 3, by way of which an adhesive 19 is transferred to a book block spine 4 of a book block 22. The book block 22 is in this case held by a clamp 23 and moved along over the adhesive application apparatus 1 in a transporting direction T. The nozzle slit 3 is opened or moved together by a first slide 6 in a way corresponding to a book block thickness 5 to be glued. The first slide 6 has a defined cross-sectional area 7 and offers space for a defined volume of adhesive 9 by the respective width of opening 8, which corresponds to the book block thickness 5. As represented in FIG. 1—the melted adhesive 19 is pumped from a premelter 18 by way of a heating tube 14 to an initially closed valve 15 and by way of the heating tube 16 back again into the premelter by a pump 20. As soon as adhesive is to be applied to the spine of the book 5, the valve 15 opens and the adhesive is pumped into a chamber 10 by way of a channel 17.

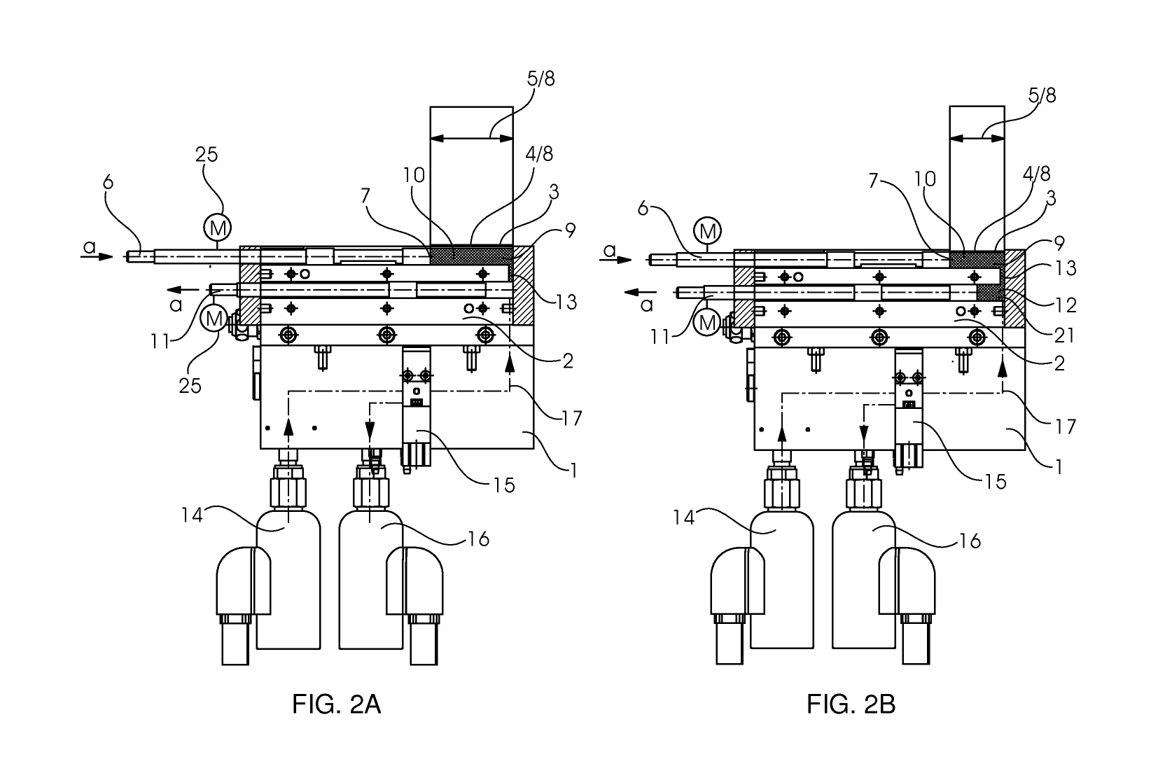

If the application width of the slit nozzle 3 is reduced, since, instead of a wide book block spine 4—as represented in FIG. 2A—a narrow book block spine 4—as represented in FIG. 2B—is now to be wetted with adhesive 19, the first slide 6 is displaced by a drive 25, as indicated by arrow a, and it displaces the adhesive 19 located in the first chamber 10. At the same time, a second slide 11 in a second chamber 12 is displaced by a further drive 25, as indicated by arrow a, such that the overall volume of the first chamber 10 and the second chamber 12 in the adhesive application head 2 is retained and the excess adhesive 19 can escape by way of a channel 13 into the second chamber 12. In other words, the volume 9 in the first chamber 10 is reduced to the same extent as the volume 21 in the second chamber 12 is increased. At this moment, the overall volume is constant, irrespective of the position of the first slide 6 in the adhesive application head 2. In order that the second slide 11 can be brought again into its readiness position, in which the volume 21 is almost zero, the adhesive 19 located in the second chamber 12 is forced back in quite small metered amounts to the first chamber 10 and unnoticeably transferred to the book block spine 4. If in this phase an opening of the nozzle slit 3 is necessary because of a book block 4 with a greater book block thickness 5, priority is given to providing the adhesive 19 from the second chamber 12, and the pumping output of the pump 20 is only increased if required. In this way it can be ensured that, even when continually changing between minimum and maximum product thickness 5, no excess adhesive 19 is provided at the nozzle slit 3 and applied to the book block spine 4.

In the exemplary embodiment that is represented, the slides 6, 11 are arranged in parallel, one above the other, and are connected at the end faces via the channel 13. The second chamber 12 could, however, also be located at the same height as the first chamber 10, on the opposite side of the nozzle slit 3.

1. An apparatus for applying adhesive to a book block spine, comprising:
an adhesive supplying system;
an application nozzle for applying the adhesive to the book block spine, said application nozzle being line-connected to said adhesive supplying system and having a nozzle opening formed therein and being variable and able to be adapted to a thickness of a book block to be processed, said application nozzle further having a first chamber for providing the adhesive and disposed adjacent said nozzle opening, and a second chamber, disposed between said nozzle opening and said adhesive supplying system;
a first slide disposed in a region of said first chamber for changing a width of said first chamber; and
a second slide disposed in a region of said second chamber for changing a volume of the second chamber.

2. The apparatus for applying the adhesive according to claim 1, further comprising:
a common control unit; and
drives, said first slide and said second slide are respectively assigned one of said drives, both said drives being connected to said common control unit by data transmission technology.

3. The apparatus for applying the adhesive according to claim 2, wherein said drives can be activated such that, when there is a change in a width of said first chamber in accordance with the thickness of the book block to be processed, a sum of a volume of said first chamber and said second chamber remains constant.

4. The apparatus for applying the adhesive according to claim 2, wherein the thickness of the book block respectively to be processed is stored in said common control unit.

5. The apparatus for applying the adhesive according to claim 2, further comprising a measuring device, said common control unit is connected by data transmission technology to said measuring device for recording the thickness of the book block to be processed.

6. A method for adapting an adhesive application nozzle of an apparatus for applying adhesive to a book block spine, to a thickness of a book block to be processed, which comprises the steps of:
a) displacing a first slide to change a width of a first chamber, in which the adhesive is provided at a nozzle opening such that a width of the first chamber is adapted to the thickness of the book block to be processed; and
b) at a same time, displacing a second slide, assigned to a second chamber between the nozzle opening and an adhesive supplying system, such that a sum of a volume of the first chamber and the second chamber remains constant.

7. The method for adapting the adhesive application nozzle according to claim 6, which further comprises only performing the step b) when the width of the first chamber is reduced.

8. The method for adapting the adhesive application nozzle according to claim 6, which further comprises:
c) withdrawing the second slide into a starting position, in which the second chamber has a minimum volume.

9. The method for adapting the adhesive application nozzle according to claim 8, which further comprises performing at least one of the withdrawing of the second slide in concert with at least one of an activation of the adhesive supplying system or withdrawing of the second slide taking place in a plurality of smaller steps.

10. The method for adapting the adhesive application nozzle according to claim 6, which further comprises setting a ratio of a displacing speed of the first slide and the second slide to be inversely proportional to a ratio of cross sections of the first slide and the second slide.

11. An apparatus for applying adhesive to a book block spine, the apparatus comprising:
an adhesive supplying system;
an application nozzle for applying the adhesive to the book block spine, said application nozzle being line-connected to said adhesive supplying system and having a nozzle opening formed therein being variable and able to be adapted to a thickness of a book block to be processed, said application nozzle having a chamber adjacent to said nozzle opening and a membrane-shaped two-dimensional element for equalizing a volume of said chamber, said membrane-shaped two-dimensional element being disposed adjacent said chamber; and
a slide for changing a width of said chamber.
